(19) United States
(12) Patent Application Publication
(10) Pub. No.: US 2019/0367823 A1
(43) Pub. Date: Dec. 5, 2019

(54) System and Method of Liquid Hydrocarbon Desulfurization Utilizing a Liquid Sorbent

(71) Applicant: Alternative Petroleum Technologies, Inc., Reno, NV (US)

(72) Inventors: Jack Lawrence Waldron, Reno, NV (US); Kylen J. Smith, Reno, NV (US)

(21) Appl. No.: 16/427,783

(22) Filed: May 31, 2019

Related U.S. Application Data
(60) Provisional application No. 62/678,308, filed on May 31, 2018.

(51) Int. Cl. C10G 53/14; B01D 11/04

(52) U.S. Cl. CPC C10G 53/14; B01D 11/0488; C10G 2300/202; C10G 2300/207; B01D 11/0449

(57) ABSTRACT

The disclosure is directed to a system and method of hydrocarbon desulfurization utilizing a liquid sorbent. The system includes a plurality of vessel pair assemblies, each of which includes a reaction vessel and a settling vessel. Hydrocarbon fuel having a sulfur content is mixed with a catalyst and an oxidant in each of the reaction vessels along with a sorbent and then transferred to the settling vessel for separating the hydrocarbon fuel having a sulfur content from the sorbent, the sorbent removing the oxidized portion of the sulfur from the hydrocarbon fuel. The sorbent is transferred from the second settling vessel to the first reaction vessel, while the hydrocarbon fuel having a sulfur content is transferred from the first settling vessel to the second reaction vessel so as to travel in opposing directions. Methods and other systems are likewise disclosed.

### CROSS-REFERENCE TO RELATED APPLICATION

This application claims priority from U.S. Pat. App. Ser. No. 62/678,308 filed May 31, 2018, entitled “System and Method of Liquid Hydrocarbon Desulfurization Utilizing A Liquid Sorbent”, the entire specification of which is hereby incorporated by reference in its entirety.

### BACKGROUND OF THE DISCLOSURE

### 1. Field of the Disclosure

The disclosure relates in general to liquid hydrocarbon desulfurization, and more particularly, to a system and method of liquid hydrocarbon desulfurization utilizing a liquid sorbent.

### 2. Background Art

Environmental concerns continue to increase with the increased use of hydrocarbon fuels, and have increased considerably with the use of these fuels in areas of the world where environmental regulations may not be as advanced as there are in other global locations.

One pollutant of hydrocarbon fuels is Sulfur, generally found in organic compounds such as thiophenes. Once combusted it becomes oxidized, that, when present in the atmosphere, has several deleterious effects. One of these effects is being a component of acid rain. Traditionally, the sulfur content of liquid hydrocarbons has been reduced by hydro-desulfurization, a process that requires relatively high temperatures and pressures in the presence of hydrogen gas to function economically. However, this technology is relatively costly, time consuming and expensive, which, in turn, limits the ability to rapidly assist countries in reducing Sulfur emissions.

Other methods have been developed for desulfurization. One of which is oxidative desulfurization, and another is bio oxidation. There are also drawbacks with these processes; overall they are promising. Among other drawbacks with oxidative desulfurization, it is difficult to efficiently use the reagents used during the oxidation step. The oxidizer is consumed in the reaction, and is quite costly. While in some systems, the oxidizer can be recycled, it remains difficult. Furthermore, there are operational issues associated with its implementation.

While the prior art is replete with patents directed to oxidative desulfurization, it has remained difficult to develop industrial processes for such innovations. Among other such prior art patents are U.S. Pat. No. 3,163,593 issued to Webster; U.S. Pat. No. 8,574,428 issued to Schucker; U.S. Pat. No. 7,758,745 issued to Cheng; U.S. Pat. No. 7,314,545 issued to Karas; U.S. Pat. No. 7,774,749 issued to Martinie; U.S. Pat. No. 6,596,914 issued to Gore; PCT Pub. No. WO2013/051202 published to Ellis and EP. App. Pub NO. 0482841 issued to Collins. Each of the foregoing patents is incorporated herein in its entirety.

### SUMMARY OF THE DISCLOSURE

The disclosure is directed to a system and method of hydrocarbon desulfurization utilizing a liquid sorbent. In the configuration described a plurality of vessel pair assemblies are provided. The liquid hydrocarbon is directed sequentially through the plurality of vessels, and liquid sorbent is directed through the plurality of vessels. Reagents are provided (comprising catalyst, oxidant, and a strong acid) that travel with the liquid hydrocarbon and the sorbent and which react with sulfur species in the liquid hydrocarbon to oxidize it so it may be removed from the liquid hydrocarbon by the sorbent.

In some aspects of the disclosure, the disclosure is directed to system for liquid hydrocarbon desulfurization comprising a plurality of vessel pair assemblies, defining at least a first vessel pair and a second vessel pair. Each vessel pair assembly has a reaction vessel, a mixing member, and a settling vessel. Each reaction vessel including a cavity, an inlet and an outlet. Each mixing member is associated with the reaction vessel configured to mix a fluid in communication with the reaction vessel. Each settling vessel has a transfer opening, a fuel outlet and a sorbent outlet.

In such a configuration the outlet of the reaction vessel is placeable in fluid communication with the transfer opening of the settling vessel.

Additionally, in such a configuration, the reaction vessel is structurally configured to mix a sorbent portion and a hydrocarbon portion.

Further, in such a configuration, the settling vessel is structurally configured to allow separation of the hydrocarbon portion from the at least the sorbent, allowing for removal of the hydrocarbon portion from the fuel outlet and removal of the sorbent portion from the sorbent outlet.

In such a configuration, the fuel outlet of the settling vessel of the first vessel pair is in fluid communication with the inlet of the reaction vessel of the second vessel pair with fluid movement direction being from the fuel outlet to the inlet. Additionally, the sorbent outlet of the settling vessel of the second vessel pair is in fluid communication with the inlet of the reaction vessel of the first vessel pair, with fluid movement direction being from the sorbent outlet to the inlet, so that, in turn, the sorbent portion and the hydrocarbon portion travel in opposing directions.

In some configurations, the mixing member forms a portion of a recirculation assembly having a conduit including a removing inlet in fluid communication with the outlet of the reaction vessel, a return outlet in fluid communication with the inlet of the reaction vessel, and having a pump configured to circulate fluid therethrough.

In some configurations, the mixing member comprises a shear plate.

In some configurations, the plurality of vessel pair assemblies comprises in excess of two vessel pairs.

In some configurations, the system further includes a transfer valve in fluid communication with the outlet of the reaction vessel and the transfer opening of the reaction vessel of each of the plurality of vessel pair assemblies.

In another aspect of the disclosure, the disclosure is directed to a method of liquid hydrocarbon desulfurization. The method comprises the steps of: providing a first vessel pair having a first reaction vessel and a first settling vessel; providing a second vessel pair having a second reaction vessel and a second settling vessel; mixing in the first reaction vessel a hydrocarbon portion and a sorbent portion; oxidizing sulfur from the hydrocarbon portion in the first reaction vessel; transferring the hydrocarbon portion and the sorbent portion into the first settling vessel and allowing the sorbent portion and the hydrocarbon fuel portion to separate; transferring the hydrocarbon portion from the first settling vessel to the second reaction vessel; removing the sorbent portion from the first settling vessel; mixing the hydrocarbon portion in the second reaction vessel with the sorbent portion, a catalyst and an oxidant to form a second mixture; oxidizing sulfur from the hydrocarbon portion in the second reaction vessel; transferring the second mixture into the second settling vessel and allowing the sorbent portion and the hydrocarbon portion content to separate; removing the hydrocarbon portion from the second settling vessel; and transferring the sorbent portion from the second settling vessel to the first reaction vessel, so that the hydrocarbon portion content travels from the first vessel pair to the second vessel pair, while the sorbent portion travels from the second vessel pair to the first vessel pair.

In some configurations, each of the steps of the method occur continuously, once a startup has been achieved, with a transfer valve being positioned between the reaction vessel and the settling vessel of each of the first vessel pair and the second vessel pair, so as to control the transfer of the mixture therebetween.

In some configurations, the hydrocarbon portion removed from the second settling vessel has a lower level of sulfur than the hydrocarbon portion from the first settling vessel.

In some configurations, the step of mixing in the first reaction vessel further comprises the step of mixing with a shear plate.

In some configurations, the step of mixing in the second reaction vessel further comprises the step of mixing with a shear plate.

In some configurations, the separation of hydrocarbon portion and the sorbent portion in the first settling vessel is achieved through gravity separation, and wherein the separation of hydrocarbon portion and the sorbent portion in the second settling vessel is achieved through gravity separation.

In some configurations, the step of mixing in the first reaction vessel further comprises the step of recirculating the hydrocarbon portion and the sorbent portion.

In some configurations, the step of mixing in the second reaction vessel further comprises the step of recirculating the hydrocarbon portion and the sorbent portion.

In some configurations, the method of liquid hydrocarbon desulfurization further comprises the steps of: providing a third vessel pair having a third reaction vessel and a third settling vessel; and repeating each of the steps of the first and second reaction vessels and settling vessels with respect to the third reaction vessel and the third settling vessel so that the hydrocarbon fuel having a sulfur content travels from the first vessel pair to the second vessel pair to the third vessel pair while the sorbent travels from the third vessel pair to the second vessel pair to the first vessel pair.

In some configurations, the sorbent portion is removed from the first settling vessel is recycled.

In some configurations, oxidant and catalyst may be added to at least one of the first reaction vessel and the second reaction vessel.

In some configurations, the catalyst in the sorbent portion comprises an organic acid. It will be understood that portions of the catalyst will be in the fuel.

In some configurations, the oxidant in the sorbent portion comprises a hydrogen peroxide. It will be understood that portions of the oxidant will be in the fuel.

In some configurations, the sorbent in the sorbent portion may comprise methanol, ethanol, propanol, acetonitrile, either separately, as a mixture among themselves, or a mixture with water. Other sorbents may also be used.

In some configurations, the sorbent portion comprises a plurality of constituents, including, a sorbent, and the sorbent is added separately from the remaining constituents. For example, the sorbent can be added after oxidation with the other sorbent portion components prior to addition to the settling vessel. Additionally, the sorbent may be cooled prior to being directed into the settling vessel.

In some configurations, the sorbent portion includes a strong acid.

In some configurations, at least one of the ratio of sorbent to hydrocarbon ranges from 2 parts sorbent to 1 part hydrocarbon, to, 1 part sorbent to 9 parts hydrocarbon; the pressure in at least the reaction vessel is atmospheric or elevated from atmospheric; and the temperature in at least the reaction vessel is between 40° C. and 90° C. Of course, variations are contemplated.

In another aspect of the disclosure, the disclosure is directed to a system for liquid hydrocarbon desulfurization. The system includes a plurality of vessel pair assemblies that define at least a first vessel pair and a second vessel pair and a third vessel pair. Each vessel pair assembly has a reaction vessel, a mixing member and a settling vessel. Each reaction vessel includes a cavity, an inlet and an outlet. Each mixing member is associated with the reaction vessel configured to mix a fluid in communication with the reaction vessel. Each settling vessel has a transfer opening, a fuel outlet and a sorbent outlet. The outlet of the reaction vessel is placeable in fluid communication with the transfer opening of the settling vessel

Additionally, the reaction vessel is structurally configured to mix a sorbent, a hydrocarbon fuel having a sulfur content, a catalyst and an oxidant. Also, the settling vessel is structurally configured to allow separation of the hydrocarbon portion from the at least the sorbent portion, allowing for removal of the hydrocarbon portion from the fuel outlet and removal of the sorbent portion from the sorbent outlet. Additionally, the fuel outlet of the settling vessel of the first vessel pair is in fluid communication with the inlet of the reaction vessel of the second vessel pair with fluid movement direction being from the fuel outlet to the inlet thereof.

Further, the fuel outlet of the settling vessel of the second vessel pair is in fluid communication with the inlet of the reaction vessel of the third vessel pair with fluid movement direction being from the fuel outlet to the inlet thereof.

Additionally, the sorbent outlet of the settling vessel of the second vessel pair is in fluid communication with the inlet of the reaction vessel of the first vessel pair, with fluid movement direction being from the sorbent outlet to the inlet.

Further, the sorbent outlet of the settling vessel of the third vessel pair is in fluid communication with the inlet of the reaction vessel of the second vessel pair, with fluid movement direction being from the sorbent outlet to the inlet. Additionally, the sorbent portion and the hydrocarbon portion travel in opposing directions.

### BRIEF DESCRIPTION OF THE DRAWINGS

The disclosure will now be described with reference to the drawings wherein:

FIG. 1 of the drawings is a schematic representation of a system of hydrocarbon desulfurization utilizing a liquid sorbent having at least three vessel pair assemblies.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

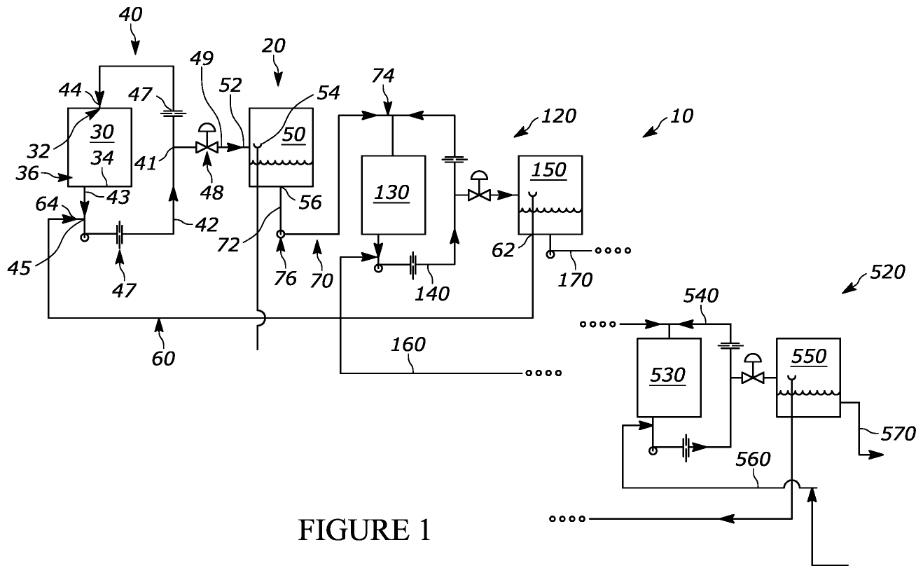

Referring now to the drawings and in particular to FIG. 1, the system for (and corresponding method of) hydrocarbon desulfurization is shown generally at 10. The system is configured to remove sulfur content from liquid hydrocarbons, such as, for example, kerosene, diesel, fuel oil, jet fuel, gasoline, heavy fuel oils, among others. The system is not limited to use with any particular type of liquid hydrocarbon. Additionally, it is contemplated that the system can lower the sulfur content to below 15 ppm, to for example 2 ppm, or less. Often times, the starting hydrocarbon has a sulfur content that can be 1500 or higher. Again, the system is not limited to use with any particular hydrocarbon, or a hydrocarbon with any particular sulfur content.

The system utilizes a liquid sorbent which is together with a strong acid catalyst and oxidant. The particular ratios can be varied depending on the particular fuel type and the composition thereof. The catalyst may comprise an organic acid which, in turn, may comprise any one of the following, without limitation, acetic, formic, benzoic, or other acid of the carboxylic family, as well as mixtures of the same. The oxidant may comprise a peroxide which, in turn, can be hydrogen peroxide or an organic peroxide, such as meta-chloroperoxybenzoic acid, an oxidized metal ion mixture, or a solid oxidizer such as Oxone. The strong acid can be either sulfuric or nitric. In some configurations, as water is dispersed in the sorbent, a strong acid may not be required, while a strong acid may be utilized. As such, other acids are likewise contemplated. The foregoing is not exhaustive, but are illustrative examples. The disclosure is not limited to these particular acids. Additionally, it is contemplated that an ionic liquid may be included or omitted from some configurations.

The liquid sorbent preferably has a low solubility for the particular liquid hydrocarbon that is to be desulfurized, and, conversely, the particular liquid hydrocarbon that is to be desulfurized preferably has a low solubility for the particular liquid sorbent. Among other contemplated sorbents, it is contemplated that the liquid sorbent may comprise methanol, ethanol, propanol, acetonitrile, among others, either separately, as a mixture among themselves, or a mixture with water. Other sorbents may also be used.

For purposes of the disclosure below, the sorbent portion shall mean the liquid sorbent, the catalyst, the oxidant (which may be liquid or solid), and other constituents that separate from the hydrocarbon fuel. The hydrocarbon portion shall mean the hydrocarbon fuel, and other constituents that are contained therein and separate from the sorbent portion. Generally, while intermingling occurs, eventually, the liquid in one of the tanks separates into the sorbent portion and the hydrocarbon portion.

The system, shown in FIG. 1, comprises a plurality of vessel pair assemblies, such as vessel pair assemblies 20, 120, 520. It will be understood that vessel pair assembly 20 generally identifies a first vessel pair assembly, vessel pair assembly 120 generally identifies a central vessel pair assembly and vessel pair assembly 520 generally identifies a final vessel pair assembly. It will further be understood that the system can be configured with a plurality of central vessel pair assemblies that are coupled together sequentially in a generally serial fashion (while some parallel arrangements within the serial coupling are contemplated as well). It is contemplated, for example, that anywhere between zero and ten central vessel pair assemblies can be utilized, again, depending on the liquid hydrocarbon, the sulfur content and other parameters.

Vessel pair assembly 20 will be described with the understanding that the vessel pair assemblies can be substantially identical to each other (with variations due to positioning, for example, as a first, central or last, as well as other variations are contemplated). Therefore, like structures will be augmented by 100 for the central vessel pair assembly 120 and by 500 for the final vessel pair assembly. The first vessel pair assembly is termed as being upstream of the central vessel pair assembly and the final vessel pair assembly, with the final vessel pair assembly being downstream of the first vessel pair assembly.

The vessel pair assembly 20 includes reaction vessel 30, recirculation assembly 40, settling vessel 50, inter vessel pair sorbent transfer conduit 60 and inter vessel pair fuel transfer conduit assembly. The reaction vessel 30 defines cavity 36 and includes inlet 32 and outlet 34. The size of the vessel 30 can be varied depending on the application and the desired output rates or flow rates of the liquid hydrocarbon. For example, such a vessel may be hundreds or thousands of liters, or, alternatively less than a hundred, less than fifty, less than twenty liters, among other variations.

The recirculation assembly 40 is shown as comprising conduit 42, pump 46, mixing members, such as mixing member 47 and transfer valve 48. The recirculation assembly provides recirculation of the contents of the reaction vessel 30, and in the configuration shown, provides ingress of sorbent portion and transfer of the sorbent portion and the hydrocarbon portion between the reaction vessel and the settling vessel.

More specifically, the conduit 42 includes removing inlet 43, return outlet 44 and sorbent inlet 45. The removing inlet 43 is in fluid communication with the outlet 34 of the reaction vessel 30. The return outlet 44 is in fluid communication with the inlet 32 of the reaction vessel 30. The sorbent inlet is positioned between the removing inlet and the return outlet.

The pump 46 is positioned inline with the conduit 42 and provides motive force for the directing of the sorbent portion and the hydrocarbon portion through the recirculation assembly, and, thereby driving the same through the mixing members 47. The mixing members may comprise any number of different mixing structures that can provide intermingling of the sorbent portion and the hydrocarbon portion. In one configuration, the mixing members 47 may comprise a shear mixer which, in turn, may be a shear plate of the type disclosed in U.S. Pat. No. 8,192,073 entitled “Mixing Apparatus and Method for Manufacturing an Emulsified Fuel” issued Jun. 5, 2012, the entire disclosure of which is incorporated herein by reference in its entirety. The mixing member is not limited to a shear mixer, or to the shear mixer that is specifically identified herein.

The transfer valve includes transfer inlet 41 in fluid communication with the conduit 42 and transfer outlet 49 in fluid communication with the transfer opening 52 (described below) of the settling vessel 50 (likewise described below). The transfer valve can be set to transfer a particular amount of sorbent portion and hydrocarbon portion continuously or may be set to periodically open and close to batch transfer, and/or through combinations of continuous and batch transfer.

The settling vessel 50 includes transfer opening 52, sorbent outlet 54 and fuel outlet 56. The settling vessel defines cavity 58 preferably corresponds in size to the reaction vessel, although it is contemplated that they may be of different capacities. The transfer opening 52 is coupled to the transfer outlet 49 of the transfer valve 48. The sorbent outlet 54 may be coupled to a sulfur removal system, for example, for liquid sorbent recycling. As will be explained below, in central and final vessel pair assemblies, the sorbent outlet 54 is coupled to the inter vessel pair sorbent transfer conduit.

The inter vessel pair sorbent transfer conduit 60 is shown as comprising inlet 62 and outlet 64. The inter vessel pair sorbent transfer conduit 60 is generally configured to direct the sorbent portion from a settling vessel of one vessel pair assembly to the recirculation assembly of a prior vessel pair assembly (i.e., from a central vessel pair assembly to a first vessel pair assembly).

The inter vessel pair fuel transfer conduit assembly 70 comprises inlet 72, outlet 74 and pump 76. The assembly 70 directs fuel from the fuel outlet of a settling vessel of one of the vessel pair assemblies to an inlet of a reaction vessel of a subsequent or downstream vessel pair assembly.

It will be understood that the region between the central vessel pair assembly and the last vessel pair assembly may include one or more additional central vessel pair assemblies, or the central vessel pair assembly can be coupled to the final vessel pair assembly, or the central vessel pair assembly can be omitted. In one configuration, a total of five vessel pair assemblies are contemplated, that is, a first and final vessel pair assembly and three central vessel pair assemblies.

In operation, and in a steady state operation, the hydrocarbon portion is directed downstream from the first vessel pair assembly to the final vessel pair assembly. The sorbent portion is directed upstream from the final vessel pair to the first vessel pair. In particular, sorbent is mixed with liquid hydrocarbon (preferably, substantially clean to clean), preferably, first so that the sorbent is saturated with fuel. Once mixed, the sorbent is added to the reaction vessel of the final vessel pair assembly. Prior to adding to the reaction vessel, reagents (i.e., the catalyst and the oxidant) are added to the sorbent, preferably, in quantities sufficient to insure the oxidation of between some and a majority, and substantially all and all of the sulfur species in the liquid hydrocarbon can be oxidized, thereby forming the initial sorbent portion.

The sorbent portion is introduced into the vessel having liquid hydrocarbon, wherein, it is contemplated that the sorbent to fuel ratio ranges from 0.1:1 sorbent solution to liquid hydrocarbon to 4:1 sorbent solution to liquid hydrocarbon.

As the oxidation occurs in each of the reaction vessels, the sulfur is removed by the sorbent relatively quickly and generally close to the time of oxidation. It will be understood that in the configuration disclosed, generally excess reagent is minimized, and it is deemed that generally little excess reagent is transferred to the fuel. It is contemplated that at any stage additional reagent can be added as necessary (as well as additional sorbent).

It will further be understood that in each of the reaction vessels, as the liquid hydrocarbon portion and the sorbent portion are recirculated/intermingled/mixed through the recirculation assembly, the step may continue for a period of time. For example, that period of time is contemplated as being on the order of five minutes to one hour. Of course, it is contemplated that the mixing may occur for less than five minutes or more than one hour, however, it is preferred that the mixing occur for between five minutes and one hour.

During the operation of the recirculation assembly, and while in the reaction vessel and the settling vessel, it is contemplated that an adequate pressure can be maintained to preclude the sorbent portion from boiling, as, it is desirable to modify the temperature of the hydrocarbon portion so as to achieve a desired range of viscosity, which aids in the movement and oxidation of the hydrocarbon portion through the process.

In the configuration wherein the hydrocarbon portion and the sorbent portion are not continuously processed or removed, and are instead batched in each of the vessel pair assemblies, the sorbent portion and the hydrocarbon portion are removed from each reaction vessel and directed through the respective transfer valve into the respective settling vessel.

After a predetermined time, the sorbent portion separates from the hydrocarbon portion, with the sorbent portion being either lighter or heavier than the hydrocarbon portion. As indicated above, the sorbent portion is removed from the respective settling vessel and directed through the inter vessel pair sorbent transfer conduit to an upstream recirculation assembly for inclusion into the reaction vessel. On the other hand, the liquid hydrocarbon portion is removed from the respective settling vessel and directed through the inter vessel pair fuel transfer conduit assembly to a downstream reaction vessel. Once the liquid hydrocarbon reaches the settling vessel of the final vessel pair assembly, the fuel has had the sulfur content reduced and can be removed for delivery, storage and/or further processing. On the other hand, once the sorbent portion is removed from the settling vessel of the first vessel pair assembly, the sorbent portion can be recycled or directed to a sorbent cleaning, recycling or disposal process.

In some configurations, the sorbent is added after the oxidation in the reactor vessel (that is after other sorbent portions are added to the reaction vessel), and preferably at a point prior to the addition to the settling chamber.

In the configurations shown, and described as being exemplary and not being limited thereto, the method is performed at ambient pressures (atmospheric), or at slightly elevated pressure, such as, for example 1-2 bar over atmospheric (while other pressures are contemplated). In the configurations shown, the temperatures of the reaction range from 40 to 95° C., more specifically 80° C. to 95° C., while other ranges are contemplated (see below), that is the temperature in the reaction vessel, and, in other portions of the system, as desired. In the configuration shown and described, temperature and pressure ranges are targeted such that the sorbent portion (that is the sorbent and reagents) do not boil during the oxidation and separation. It will be understood that temperatures above 100° C., for example, can be utilized when the system is under the slightly elevated pressures generally up to the sorbent steam saturation temperature for that pressure. Sorption temperatures are generally in same range as the reaction temperatures, although cooling to 25° C. may be desired for some sorbents. Such cooling would preferably occur prior to the insertion into the settling vessel.

Reaction times for the oxidation step are in a range from 10 minutes to 30 minutes, depending on the hydrocarbon and other reagent concentrations, and while variations are contemplated. Sorbent contact times range from 0.1 minutes to 5 minutes if contacted separately, again, while variations are contemplated. It is contemplated that the sorbent to liquid hydrocarbon ratio ranges from approximately 2 parts sorbent to 1 part liquid hydrocarbon to, for example, 1 part sorbent to 9 parts liquid hydrocarbon. Of course, other configurations are contemplated.

Advantageously, the system allows for the sorbent and the reagent to travel together. As such, reagents are maintained throughout the process, and not removed. Additionally, further oxidant can be added at any stage, which assists with the reagent control. Furthermore, by removing sulfur during contact with the reagents by the sorbent, waste of oxidant can be minimized. Furthermore, both the sorbent portion and the liquid hydrocarbon portion are maintained as fluids, there is a cost savings with respect to construction of the vessel pair assemblies.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A system for liquid hydrocarbon desulfurization comprising:
a plurality of vessel pair assemblies, defining at least a first vessel pair and a second vessel pair, each vessel pair assembly having:
a reaction vessel including a cavity, an inlet and an outlet;
a mixing member associated with the reaction vessel configured to mix a fluid in communication with the reaction vessel;
a settling vessel having a transfer opening, a fuel outlet and a sorbent outlet;
wherein the outlet of the reaction vessel is placeable in fluid communication with the transfer opening of the settling vessel,
wherein the reaction vessel is structurally configured to mix a sorbent portion and a hydrocarbon portion; and
wherein the settling vessel is structurally configured to allow separation of the hydrocarbon portion from the sorbent portion, allowing for removal of the hydrocarbon portion from the fuel outlet and removal of the sorbent portion from the sorbent outlet;
wherein the fuel outlet of the settling vessel of the first vessel pair is in fluid communication with the inlet of the reaction vessel of the second vessel pair with fluid movement direction being from the fuel outlet to the inlet;
wherein the sorbent outlet of the settling vessel of the second vessel pair is in fluid communication with the inlet of the reaction vessel of the first vessel pair, with fluid movement direction being from the sorbent outlet to the inlet, so that, in turn, the sorbent and the hydrocarbon fuel having a sulfur content travel in opposing directions.

2. The system of claim 1, wherein the mixing member forms a portion of a recirculation assembly having a conduit including a removing inlet in fluid communication with the outlet of the reaction vessel, a return outlet in fluid communication with the inlet of the reaction vessel, and having a pump configured to circulate fluid therethrough.

3. The system of claim 2 wherein the mixing member comprises a shear plate.

4. The system of claim 1 wherein the plurality of vessel pair assemblies comprises in excess of two vessel pairs.

5. The system of claim 1 further comprising a transfer valve in fluid communication with the outlet of the reaction vessel and the transfer opening of the reaction vessel of each of the plurality of vessel pair assemblies.

6. A method of liquid hydrocarbon desulfurization comprising the steps of:
providing a first vessel pair having a first reaction vessel and a first settling vessel;
providing a second vessel pair having a second reaction vessel and a second settling vessel;
mixing in the first reaction vessel a hydrocarbon portion and a sorbent portion;
oxidizing sulfur from the hydrocarbon portion in the first reaction vessel;
transferring the hydrocarbon portion and the sorbent portion into the first settling vessel and allowing the sorbent portion and the hydrocarbon portion to separate;
transferring the hydrocarbon portion from the first settling vessel to the second reaction vessel;
removing the sorbent portion from the first settling vessel;
mixing the hydrocarbon portion in the second reaction vessel with a sorbent portion;
oxidizing sulfur from the hydrocarbon portion in the second reaction vessel;
transferring the second mixture into the second settling vessel and allowing the sorbent portion and the hydrocarbon portion to separate;
removing the hydrocarbon portion from the second settling vessel; and
transferring the sorbent portion from the second settling vessel to the first reaction vessel, so that the hydrocarbon portion travels from the first vessel pair to the second vessel pair, while the sorbent portion travels from the second vessel pair to the first vessel pair.

7. The method of liquid hydrocarbon desulfurization of claim 6 wherein each of the steps of the method occur continuously, once a startup has been achieved, with a transfer valve being positioned between the reaction vessel and the settling vessel of each of the first vessel pair and the second vessel pair, so as to control the transfer of the mixture therebetween.

8. The method of liquid hydrocarbon desulfurization of claim 6 wherein the hydrocarbon portion removed from the second settling vessel has a lower level of sulfur than the hydrocarbon portion from the first settling vessel.

9. The method of liquid hydrocarbon desulfurization of claim 6 wherein the step of mixing in the first reaction vessel further comprises the step of mixing with a shear plate.

10. The method of liquid hydrocarbon desulfurization of claim 9 wherein the step of mixing in the second reaction vessel further comprises the step of mixing with a shear plate.

11. The method of liquid hydrocarbon desulfurization of claim 6 wherein the separation of the hydrocarbon portion and the sorbent portion in the first settling vessel is achieved through gravity separation, and wherein the separation of the hydrocarbon portion and the sorbent portion in the second settling vessel is achieved through gravity separation.

12. The method of liquid hydrocarbon desulfurization of claim 6 wherein the step of mixing in the first reaction vessel further comprises the step of recirculating the first mixture.

13. The method of liquid hydrocarbon desulfurization of claim 6 wherein the step of mixing in the second reaction vessel further comprises the step of recirculating the second mixture.

14. The method of liquid hydrocarbon desulfurization of claim 6 further comprising the steps of:
providing a third vessel pair having a third reaction vessel and a third settling vessel;
repeating each of the steps of claim 6 with respect to the third reaction vessel and the third settling vessel so that the hydrocarbon portion travels from the first vessel pair to the second vessel pair to the third vessel pair while the sorbent portion travels from the third vessel pair to the second vessel pair to the first vessel pair.

15. The method of liquid hydrocarbon desulfurization of claim 6 wherein the sorbent portion removed from the first settling vessel is recycled.

16. The method of liquid hydrocarbon desulfurization of claim 6 wherein oxidant and catalyst may be added to at least one of the first reaction vessel and the second reaction vessel as part of the sorbent portion.

17. The method of liquid hydrocarbon desulfurization of claim 6 wherein a catalyst of the sorbent portion comprises an organic acid.

18. The method of liquid hydrocarbon desulfurization of claim 6 wherein an oxidant of the sorbent portion comprises a hydrogen peroxide.

19. The method of liquid hydrocarbon desulfurization of claim 6 wherein a sorbent in the sorbent portion comprises one of the group selected from methanol, ethanol, propanol, acetonitrile, among others, which may be mixed and which may be combined with water.

20. The method of liquid hydrocarbon desulfurization of claim 6 wherein the sorbent portion comprises a plurality of constituents, including, a sorbent, and the sorbent is added separately from the remaining constituents.

21. The method of liquid hydrocarbon desulfurization of claim 20 wherein the method further includes the step of cooling the sorbent prior to the step of adding the sorbent.

22. The method of liquid hydrocarbon desulfurization of claim 6 wherein the sorbent portion further includes a strong acid.

23. The method of liquid hydrocarbon desulfurization of claim 6 wherein at least one of:
the ratio of sorbent to hydrocarbon ranges from 2 parts sorbent to 1 part hydrocarbon, to, 1 part sorbent to 9 parts hydrocarbon;
the pressure in at least the reaction vessel is atmospheric or elevated from atmospheric; and
the temperature in at least the reaction vessel is between 40° C. and 90° C.

24. A system for liquid hydrocarbon desulfurization comprising:
a plurality of vessel pair assemblies, defining at least a first vessel pair and a second vessel pair and a third vessel pair, each vessel pair assembly having:
a reaction vessel including a cavity, an inlet and an outlet;
a mixing member associated with the reaction vessel configured to mix a fluid in communication with the reaction vessel;
a settling vessel having a transfer opening, a fuel outlet and a sorbent outlet;
wherein the outlet of the reaction vessel is placeable in fluid communication with the transfer opening of the settling vessel,
wherein the reaction vessel is structurally configured to mix a sorbent portion, and a hydrocarbon portion; and
wherein the settling vessel is structurally configured to allow separation of the hydrocarbon portion from the at least the sorbent, allowing for removal of the hydrocarbon portion from the fuel outlet and removal of the sorbent portion from the sorbent outlet;
wherein the fuel outlet of the settling vessel of the first vessel pair is in fluid communication with the inlet of the reaction vessel of the second vessel pair with fluid movement direction being from the fuel outlet to the inlet thereof;
wherein the fuel outlet of the settling vessel of the second vessel pair is in fluid communication with the inlet of the reaction vessel of the third vessel pair with fluid movement direction being from the fuel outlet to the inlet thereof;
wherein the sorbent outlet of the settling vessel of the second vessel pair is in fluid communication with the inlet of the reaction vessel of the first vessel pair, with fluid movement direction being from the sorbent outlet to the inlet;
wherein the sorbent outlet of the settling vessel of the third vessel pair is in fluid communication with the inlet of the reaction vessel of the second vessel pair, with fluid movement direction being from the sorbent outlet to the inlet.
wherein, the sorbent portion and the hydrocarbon fuel portion travel in opposing directions.
